(19) United States
(12) Patent Application Publication
(10) Pub. No.: US 2007/0038456 A1
(43) Pub. Date: Feb. 15, 2007

(54) Text inputting device and method employing combination of associated character input method and automatic speech recognition method

(75) Inventor: Tien-Ming Hsu, Taoyuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan Hsien (TW)

(21) Appl. No.: 11/454,575

(22) Filed: Jun. 16, 2006

(30) Foreign Application Priority Data
Aug. 12, 2005 (TW) 094127655

(51) Int. Cl. G10L 21/00

(52) U.S. Cl. 704/270

(57) ABSTRACT

The text inputting device and inputting method of a mobile communication apparatus are provided in the present invention. The proposed text inputting device includes a keyboard for keying in a code of a word according to the associated character input method, a microphone for inputting a voice according to an automatic speech recognition method, and a microprocessor coupled to the keyboard and the microphone for generating at least a candidate of the word according to the code and for comparing the at least one candidate with the voice according to the automatic speech recognition method so as to choose the word from the at least one candidate.

### FIELD OF THE INVENTION

The present invention relates to a text input device and method for the mobile communication apparatus, and more particular to a text input device and method employing the combination of an associated character input method and an automatic speech recognition method for the mobile communication.

### BACKGROUND OF THE INVENTION

The present text input device for the mobile communication apparatus, such as a cell phone or a personal digital assistant, is still inconvenient to the user. In the conventional input method, the user may press many keys for inputting an English letter or a phonetic symbol.

The recently popular associated input method, such as T9, for inputting each English letter or phonetic symbol only needs to press a key. Then the resultant English words or Chinese words are the possible combinations found out by the method of searching the dictionary and listed to provide the choices for the user. Please refer to FIG. 1, which shows the diagram of a conventional text input keyboard of a cell phone. The associated input method, such as T9, can be illustrated according to FIG. 1 as follows. For example, inputting the English word “me” should press 6 3 and the “select” key (not shown), and inputting the Chinese word [symbol] [symbol] should press 2 0 9 and the “select” key and then press 3 0 9 and the “select” key. When the “*” key is pressed, plural commonly used symbols are shown for the user to select, and when the “#” key is pressed, the input methods can be changed, for example the Chinese input method (phonetic symbols) is changed to the English input method (English letters/ciphers).

Please refer to FIG. 2, which shows a flow chart of a conventional associated input method, such as T9. The first step is: pressing the key once for inputting a letter or phonetic symbol (step 21), which shows a user keys in an English letter or a Chinese phonetic symbol for inputting a term. The term could be a Chinese word, an English word string, or an English word. The English word string is composed of at least an English letter. The complete input of the phonetic symbols of a Chinese word is for searching the candidates for the desired Chinese word. The second step of the input method is: checking if the first step is complete (step 22). If the first step is complete, the process will go to the third step: inquiring the dictionary and listing at least a candidate (step 23), which inquires a dictionary 25 according to the complete inputted letters, ciphers, or phonetic symbols for listing the at least a candidate of the desired term in a predetermined sequence (e.g. listing in a sequence according to the use frequency of each term). If the first step is not complete, the process will go back to the first step (step 21). The fourth step is: pressing the controlling keys for selection (step 24), which means that if the first listed candidate is not the desired one, the user can select the right one by using the controlling keys. Of course, if the first listed candidate is the desired term, the user can select it directly.

The method makes the input process simpler and allows the user to find out the desired term by pressing less keys. However, if there are many possible combinations and the first listed candidate is not the desired term, the user still has to select the desired term by pressing the controlling keys, for example, pressing 6 3 for words: of, me. . . etc.; pressing 2 0 9 for words: [symbol] . . . etc.; and pressing 3 0 9 for words: [symbol] [symbol] . . . etc. When the user wants to input the word “me”, he needs to press 6 3, and then press the down-key (not shown) once. When the user wants to input the term [symbol] , he needs to press 2 0 9, the down-key three times, 3 0 9, and then the down-key four times. Besides, when the user wants to input the English, Chinese and ciphers at the same time, he needs to switch the input methods manually, which is also inconvenient.

Thus, for the user, if there is an easy method for picking up the candidates, the text input process will be more convenient. Moreover, another conventional technique in this field, i.e. a speech recognition method, is also used. That is, the user inputs a speech of a term to be inputted into a mobile communication device via an input device such as a microphone. The mobile communication device recognizes the speech by using a speech recognition technique, and searches the candidates from a dictionary to provide the candidates for selection. The problems are that when the speech recognition rate is low, the candidates may not include the desired term, or the amount of the candidates is large and consumes the user much time to pick up the desired term. However, if the speech recognition method is added into the associated character input method and the input speech recognition is used to rearrange the candidates produced by the associated character input method and generate a new selecting sequence by the resemblance of the speech, the user can find out the desired term quickly from the plural candidates. Besides, the user can speak the Chinese, the English or the cipher directly and pick up the candidates by the speech without switching the input methods. Therefore, combining the advantages of the associated character input method and the speech recognition method does provide a more convenient and faster text input interface.

As above-mentioned, in order to input text faster and more convenient, a text inputting device and method employing the combination of an associated character input method and an automatic speech recognition method are provided in the present invention.

### SUMMARY OF THE INVENTION

In accordance with a main aspect of the present invention, a text inputting device and method employing the combination of an associated character input method and an automatic speech recognition method are provided, which can be applied to a mobile communication device. Because the associated character input method has the advantages of a simple input process and selecting terms by the speech recognition, it provides a faster and more convenient text input interface for the user.

Another aspect of the prevent invention is to provide a text input device for a mobile communication apparatus including an inputting device, a receiver and a microprocessor. The inputting device inputs a code of a term according to an associated character input algorithm. The receiver receives a speech according to a speech recognition algorithm. The microprocessor is coupled to the inputting device and the receiver generates at least a candidate of the term according to the associated character input algorithm and compares the at least a candidate with the speech according to the speech recognition algorithm so as to select out the term from the at least a candidate.

According to the aspect above, the term is one selected from the group consisting of a separate word, a word string, a cipher and a commonly used symbol.

According to the aspect above, the separate word is one selected from the group consisting of a Chinese word, a Japan word, a Korean word, an English word, a German word, a French word, a Spanish word, an Arabic word, a Russian word, an Italic word, a Portuguese word, a Netherland word, a Greek word, a Czech word and a Denmark word.

According to the aspect above, the word string is composed of at least a letter and is one selected from the group consisting of an English word string, a German word string, a French word string, a Spanish word string, an Arabic word string, a Russian word string, an Italic word string, a Portuguese word string, a Netherland word string, a Greek word string, a Czech word string and a Denmark word string.

According to the aspect above, the code is one selected from the group consisting of the letter, the phonetic symbol and the cipher.

According to the aspect above, the microprocessor further comprises a memory device and a microcontrol unit. The memory device stores a data base, the associated character input algorithm and the speech recognition algorithm. The data base comprises an associated character input dictionary and a speech learning model. The associated character input dictionary generates the at least a candidate according to the code. The microcontrol unit is coupled to the memory device, performs the associated character input algorithm and the speech recognition algorithm and compares the at least a candidate with the speech according to the speech learning model so as to obtain the term.

According to the aspect above, the associated character input dictionary stores the letter, the phonetic symbol, the separate word, the cipher, and the commonly used symbol.

According to the aspect above, the associated character input algorithm generates a first sequence according to a use frequency of the at least a candidate from high to low.

According to the aspect above, the speech recognition algorithm compares the at least a candidate with a pronunciation of the speech by the speech learning model according to the first sequence so as to generate a second sequence and pick up the term according thereto.

According to the aspect above, the text input device further comprises a monitor coupled to the microprocessor and shows one selected from the group consisting of the code, the at least a candidate and the term.

According to the aspect above, the monitor shows the at least a candidate according to the first sequence and the second sequence.

According to the aspect above, the inputting device inputs at least one selected from the group consisting of a letter, a phonetic symbol, a plurality of commonly used symbols and a cipher.

According to the aspect above, the phonetic symbol is one selected from the group consisting of a Chinese phonetic symbol, a Japan phonetic symbol and a Korean phonetic symbol.

According to the aspect above, when two codes from the inputting device are respectively inputted by two different input methods, the two codes are inputted directly through the inputting device according to the two different input methods without switching.

According to the aspect above, the speech is a speech of the term pronounced by a user.

According to the aspect above, the mobile communication apparatus is one of the mobile phone and the personal digital assistant.

Another aspect of the present invention is to provide a text input device for a mobile communication apparatus comprising an inputting device, a receiver and a microprocessor. The microprocessor is coupled to the inputting device and receiver, and comprises a memory device and a microcontrol. The memory device comprises a data base, an associated character input algorithm and a speech recognition algorithm. The data base comprises an associated character input dictionary and a speech learning model. The associated character input dictionary generates at least a candidate of the term according to the code. The associated character input algorithm generates a first sequence of the at least a candidate. The speech recognition algorithm generates a second sequence of the at least a candidate. The microcontrol unit is coupled to the memory device, performs the associated character input algorithm and the speech recognition algorithm and compares the at least a candidate with the speech according to the speech learning model and the first sequence so as to generate the second sequence for picking up the term.

According to the aspect above, the inputting device inputs one selected from the group consisting of an English letter, a phonetic symbol, plural commonly used symbols, and a cipher.

According to the aspect above, the associated character input dictionary stores plural phonetic symbols, plural English letters, plural Chinese words, plural English words, plural ciphers, and plural commonly used symbols.

According to the aspect above, the term is one selected from the group consisting of a Chinese word, an English word string, an English word, a cipher, and a commonly used symbol.

According to the aspect above, the English word string is composed of at least an English letter.

Another aspect of the present invention is to provide a text input method for a mobile communication apparatus having an input device comprising an inputting device, a receiver, a monitor, and a data base having an associated character input dictionary and a speech learning model. The text input method comprises steps of (a) inputting a code selected from the group consisting of a letter, a phonetic symbol, plural common used symbols, and a cipher through the inputting device, (b) showing in the inputted code by the monitor, (c)checking whether the code is inputted completely, if yes, searching the associated character input dictionary so as to show at least a candidate by a first sequence according to the code, and, if not, repeating steps (a) and (b), (d) inputting a speech from the receiver, (e) comparing a pronunciation of the at least a candidate with the speech by the first sequence through the speech learning model so as to generate a second sequence, (f) showing the at least a candidate by the monitor according to the second sequence and then picking up a term, and (g) showing the term by the monitor.

Another aspect of the prevent invention is to provide a text input method for a mobile communication apparatus. The text input method comprises steps of (a) inputting a code according to an associated character input method, (b) showing the inputted code by the mobile communication apparatus, (c) checking whether the code is inputted completely, if not, repeating steps (a) and (b), and, if yes, generating at least a candidate of a term and a first sequence according to the associated character input method and the code, (d) showing the at least a candidate in the mobile communication apparatus according to the first sequence, (e) inputting a speech, (f) comparing a pronunciation of the at least a candidate with the speech by the first sequence and through a speech recognition method so as to generate a second sequence of the term, and (g) showing the at least a candidate by the second sequence in the mobile communication apparatus and then picking up a term according thereto.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows a text input keyboard of the conventional mobile phone;

FIG. 2 shows a flow chart of the conventional associated character input method;

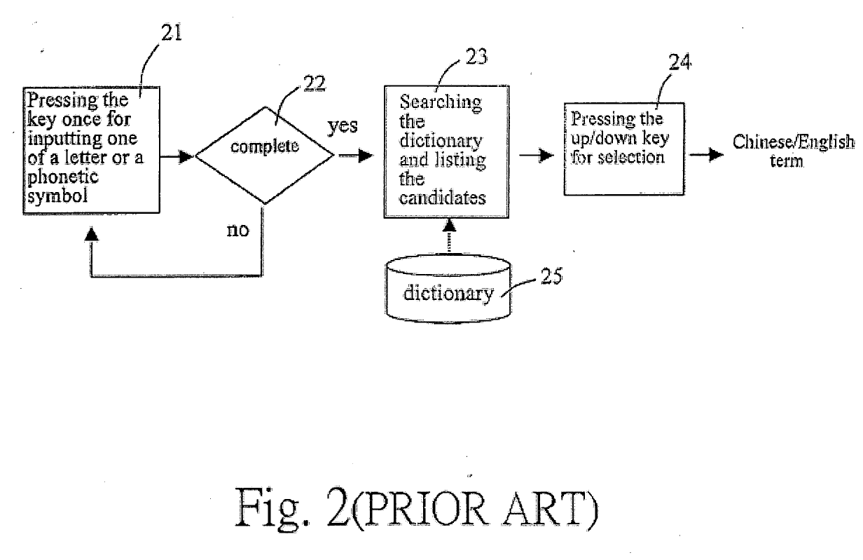

FIG. 3 shows a flow chart of the text input method for a mobile phone according to the preferable embodiment of the present invention;

FIG. 4 shows a detailed flow chart of the speech recognizing and selecting step in FIG. 3; and

FIG. 5 shows the structure of the preferable embodiment of the text input device for the mobile communication device according to the present invention.

### DETAILED DESCRIPTION OF THE PREFERRED EMBODIMENT

As the foregoing, by using the conventional associated character input method such as T9, the user only needs to press a key for each English letter or phonetic symbol. Finally, the resultant English words or Chinese words are the possible combinations of candidates searched from the dictionary and listed for the user to select. The present invention combines the advantages of the associated character input method and the speech recognition, which can not only show a first sequence of the candidates by pressing a code of a term according to the associated character input method, but also compare the candidates to a speech inputted by a user to generate a second sequence for selection. The code of a term could be one of at least a phonetic symbol, a letter or a cipher for representing the desired term. The first sequence lists the candidates according to the use frequency from high to low, and the second sequence lists the candidates according to the simulation of the speech. The present invention generates a limited number of candidates by the associated character input method, and the limited number of candidates are further confirmed by the speech recognition method, and thus the accuracy could be raised over 95 percent. Accordingly, the user can pick up the desired term very fast. The present invention has the above advantages, so the text input process will be more convenient by using the text input method of the present invention

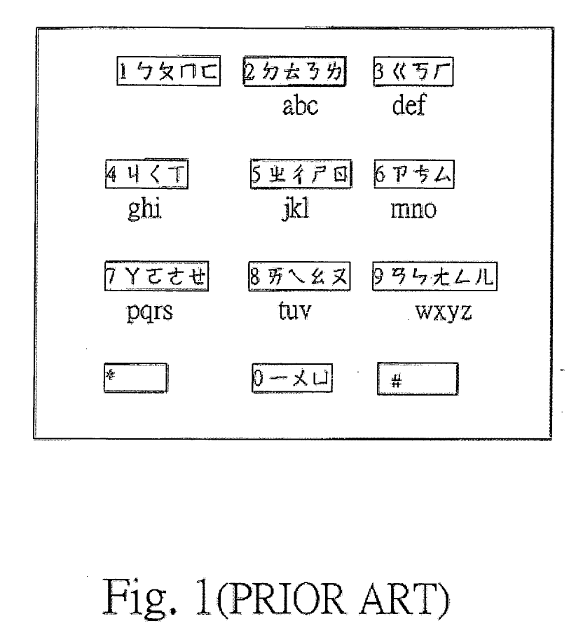

Please refer to FIG. 1 again, which shows a text input keyboard of the conventional mobile phone. For example, press 6 3 for words: of, me. . . etc.; press 2 0 9 for words: [symbol] . . . etc. Therefore, when the user wants to input “me”, he may press 6 3 and speak “me”. When the user wants to input [symbol] , he may press 2 0 9 and speak [symbol] , and then press 3 0 9 and speak [symbol] (or press 2 0 9 and 3 0 9 and then speak [symbol] ).

When the Chinese, English and cipher are inputted simultaneously, it needs not to switch manually. All it needs is to speak after the key-pressing input. For example, press 2 8 for words: [symbol] at, au, bt, bu, 28. . . etc.; press 2 7 for words: [symbol] as, ar, bs, cs, 27.. .etc.; press 2 0 9 for words: [symbol] aw, ax, ay, by, cy, 209.. etc. When the user wants to input “as [symbol] at 209”, he needs to press 2 7 and speak “as”, press 2 8 2 7 2 0 9 and speak [symbol] , press 2 8 and speak “at”, and press 2 0 9 and speak “209”.

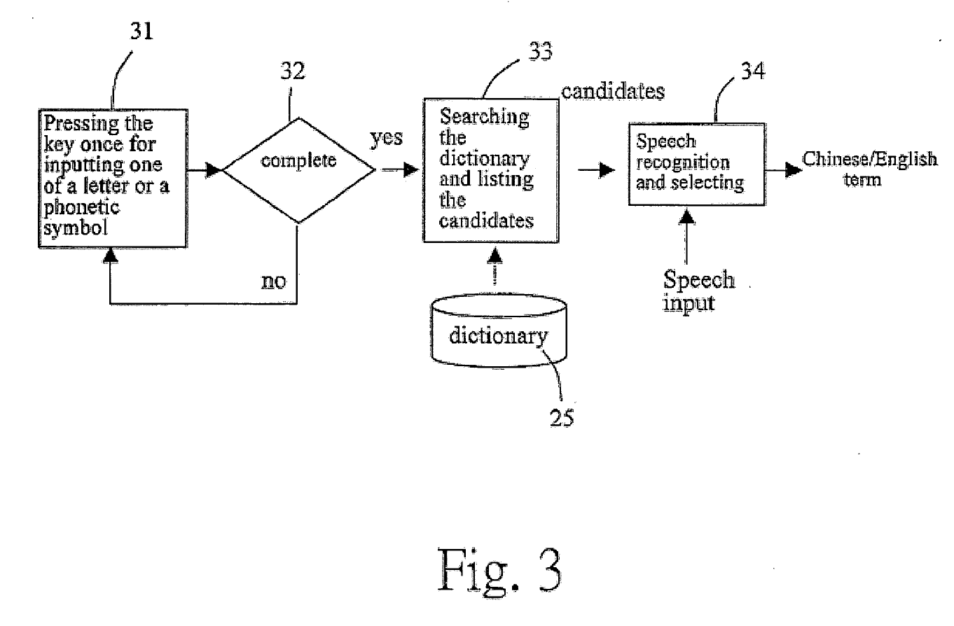

Please refer to FIG. 3, which shows a flow chart of the text input method for a mobile phone according to the preferable embodiment of the present invention. The first step is: pressing the key once for inputting a letter or phonetic symbol (step 31), which means that the user inputs an English letter (including a cipher) or a phonetic symbol by pressing a key for inputting a term. The term could be a Chinese word, a cipher, plural commonly used symbols, an English word string or an English word. The English word string is composed of at least an English letter, and the completely keyed in phonetic symbols of the Chinese word are used for searching the candidates of the Chinese word. The second step of the input method is: checking if the first step is completed (step 32). If the first step is completed, the process goes to the third step: inquiring the dictionary and listing the candidates (step 33), which inquires the dictionary 25 according to the completely keyed in letters, ciphers or phonetic symbols and lists at least a candidate. Besides, the candidates are arranged in a first selecting sequence (for example, the sequence is generated according to the use frequency of each word). If the first step is not completed, the process goes back to the first step (step 31). The fourth step is: speech recognizing and selecting (step 34), which compares a speech from the user to the candidates generated by the step 33 and listed by the original associated character input method to generate a second selecting sequence (listed according to the simulation of the pronunciation from high to low) for the user to pick up the term, where the term with the highest ranking might be the most possible term. If the candidate is the desired term, it will be outputted directly. If the candidate is not the desired term, the user may select the desired term by the controlling keys.

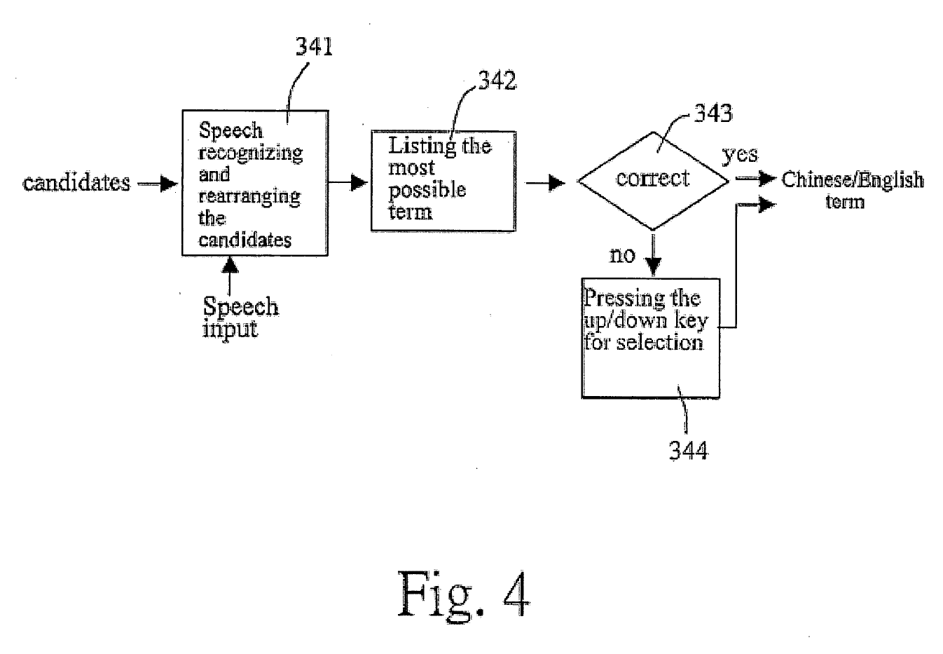

Please refer to FIG. 4, which shows the detailed flow chart of the speech recognizing and selecting step (step 34) in FIG. 3. The speech recognizing and selecting step further includes the following steps. In step 341, the candidate is rearranged by speech recognizing, the input speech is compared to the first sequence according to the original associated character input method, and then a second sequence is generated according to the resemblance of the speech. In step 342, the most possible terms are shown, wherein the term with the highest ranking in the second sequence, i.e. the most possible term, will be in the first place for the user's selection. In step 343, whether the term is correct or not is checked, which means that if the most possible term is correct, the user will select it and input the Chinese/English word; if the most possible term is not correct, the process goes to step 344: selecting by using the up or down key. That is to say, if the most possible term is not the desired term, the user can press the up or down key to select the desired term. As the foregoing, the recognizing rate could be over 95% by using the speech recognizing technology with a less amount of vocabularies. Therefore, the recognizing result of the most possible term generated through the step 342 of the present invention is usually the desired term. Even if a 5% error exists, the correct terms are mostly present in the second or third ranking, which is convenient for the user to select by pressing the controlling keys. Thus, the present invention combines the advantages of the associated character input method and the speech recognizing method that provides a faster and more convenient text input interface for the user.

As described above, the present invention provides a text input method for the mobile communication apparatus, which comprises the following steps: (a) inputting a code of a term once according to an associated character input method, (b) showing the inputted code on the mobile communication apparatus, (c) checking whether the code is inputted completely, if yes, generating at least a candidate of a term and a first sequence according to the associated character input method and the code, and, if not, going to step (a); (d) showing the at least a candidate on the mobile communication apparatus according to the first sequence; (e) inputting a speech; (f) comparing a pronunciation of the at least a candidate with the speech by the first sequence and through a speech recognition method so as to generate a second sequence of the term; (g) showing the at least a candidate by the second sequence on the mobile communication apparatus and then picking up a term according thereto.

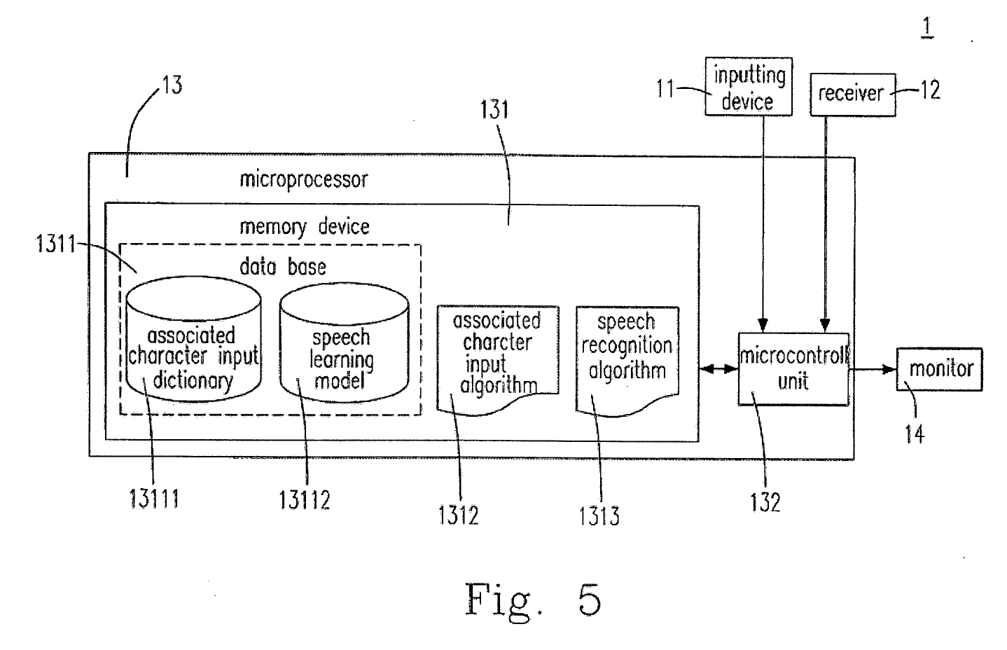

Please refer to FIG. 5, which shows the structure of the preferable embodiment of the text input device for the mobile communication device according to the present invention. As shown in FIG. 5, a text input device 1 of the mobile communication apparatus comprises an inputting device 11 (e.g. a keyboard), a receiver 12 and a microprocessor 13. The inputting device 11 is used for inputting a code of a term according to an associated character input algorithm. The receiver 12 receives a speech according to a speech recognition algorithm. The microprocessor 13 is coupled to the inputting device 11 and the receiver 12, and generates at least a candidate of the term according to the associated character input algorithm and compares the at least a candidate with the speech according to the speech recognition algorithm so as to select out the term from the at least a candidate. The microprocessor 13 further comprises a memory device 131 and a microcontrol unit 132. The memory device 131 stores a data base 1311, the associated character input algorithm 1312 and the speech recognition algorithm 1313. The data base 1311 has an associated character input dictionary 13111 and a speech learning mode 13112. The associated character input dictionary 13111 generates the at least a candidate according to the code. The microcontrol unit 132 is coupled to the memory device 131, performs the associated character input algorithm 1312 and the speech recognition algorithm 1313, and compares the at least a candidate with the speech according to the speech learning model 13112 so as to obtain the term. Besides, the text input device 1 further comprises a monitor 14 which is coupled to the microprocessor 13 and shows one selected from the group consisting of the code, the at least a candidate and the term inputted by the inputting device 11. The term is one selected from the group consisting of one of a letter of a separate word or a word string, one of the cipher or a commonly used symbol. The separate word described above could be one of any kinds of languages inputted into a mobile communication apparatus by the associated character input method, such as Chinese, English and so on. Presently, there are more than forty languages which can be inputted into a mobile communication apparatus via the associated character input method. Therefore, the separate word could be one selected from the group consisting of a Chinese word, a Japan word, a Korean word, an English word, a German word, a French word, a Spanish word, an Arabic word, a Russian word, an Italic word, a Portuguese word, a Netherland word, a Greek word, a Czech word and a Denmark word. The word string is composed of at least one letter of a word having plural letters (the word is composed of letters, for example, English has 26 letters). Therefore, the word string could be one selected from the group consisting of an English word string, a German word string, a French word string, a Spanish word string, an Arabic word string, a Russian word string, an Italic word string, a Portuguese word string, a Netherland word string, a Greek word string, a Czech word string and a Denmark word string. Besides, the inputting device 11 can once input one selected from the group consisting a letter of the word, a phonetic symbol, plural commonly used symbols or a cipher according to the associated character input method. A phonetic symbol marking the pronunciation of a word is inputted for representing the code of the word. For example, the phonetic symbol could be one selected from the group consisting of a Chinese phonetic symbol, a Japan phonetic symbol and a Korean phonetic symbol. The associated character input dictionary 13111 stores plural letters, plural phonetic symbols, plural separate words, plural ciphers and plural commonly used symbols of the at least one language inputted into the mobile communication apparatus. The code described above is one selected from the group consisting of the at least one letter, the at least one phonetic symbol and the at least one cipher. The associated character input algorithm 1312 generates a first sequence according to the score of the at least candidate (for example, according to the use frequency) from high to low. The speech recognition algorithm 1313 generates a second sequence according to the speech learning model 13112, compares the simulation of the pronunciation of the candidate to the speech (for example, generating a score representing the simulation), and selects the term according thereto. Furthermore, the monitor 14 shows the at least one candidate according to the first sequence and the second sequence. When the serial two inputs inputted via the inputting device 11 use two different input methods (for example, the first one uses the Chinese input method and the second one uses the English input method), the user does not need to switch the input methods and only needs to press the two input codes directly via the inputting device 11. The input speech via the receiver 12 is a pronunciation of the term spoke by the user. The text input device 1 of the present invention can be applied to any mobile communication apparatus which can work therewith. For example, the mobile communication apparatus can be one of a mobile phone or a personal digital assistant (PDA).

Please refer to FIG. 5 again. In the following, we will analyze the text input device 1 for the mobile communication apparatus according to the interactions and the functions of each component thereof. The text input device 1 comprises an inputting device 11, a receiver 12 and a microprocessor 13. The inputting device 11 is used for inputting a code of a term. The receiver 12 receives a speech. The microprocessor 13 is coupled to the inputting device 11 and the receiver 12, and further comprises a memory device 131 and a microcontrol unit 132. The memory device 131 stores a data base 1311, the associated character input algorithm 1312 and the speech recognition algorithm 1313. The data base 1311 has an associated character input dictionary 13111 and a speech learning mode 13112. The associated character input dictionary 13111 generates the at least a candidate according to the code. The associated character input algorithm 1312 generates a first sequence of the candidates. The speech recognition algorithm 1313 generates a second sequence of the candidates. The microcontrol unit 132 is coupled to the memory device 131, performs the associated character input algorithm 1312 and the speech recognition algorithm 1313, and compares the candidates of the first sequence to the speech and generates the second sequence according to the speech learning model 13112 so as to obtain the term. The monitor 14 has the same function as that described above.

Generally, in a country or an area, the input language for the mobile communication apparatus should be the most popular language in the country or area (e.g. Chinese) or the most popular language in the world (e.g. English). Because the more languages the text input device can input, the more complex the system structure or the relevant software will be, and the production cost will become higher. Take the above-mentioned mobile communication apparatus which can input Chinese/English for example, the inputting device 11 is used to once input one selected from the group consisting an English letter, a phonetic symbol, plural commonly used symbols and a cipher. The associated character input dictionary 13111 stores plural phonetic symbols, plural English letters, plural Chinese words, plural English words, plural ciphers and plural commonly used symbols. The term is one selected from the group consisting of a Chinese word, an English word string, an English word, a cipher and a commonly used symbol. The English word string is composed of at least an English letter.

Please refer to FIG. 5 again, which shows the structure of the preferable embodiment of the text input device 1 for the mobile communication device. If the text input method is analyzed based on the components thereof provided by the present invention, the operation principles and steps could be described as follows. The text input method for a mobile communication apparatus is used in an input device 1, which comprises an inputting device 11, a data base 1311 having an associated character input dictionary 13111 and a speech learning model 13112, a receiver 12 and a monitor 14. The method comprises the following steps: (a) inputting a code selected from the group consisting of a letter, a phonetic symbol, plural commonly used symbols, and a cipher through the inputting device 11; (b) showing the inputted code by the monitor 14; (c) checking whether the code is inputted completely, if not, repeating steps (a) and (b), and, if yes, generating at least a candidate of a term and a first sequence according to the associated character input method and the code; (d) showing the at least a candidate by the monitor 14 according to the first sequence; (e) inputting a speech via the receiver 12; (f) comparing a pronunciation of the at least a candidate with the speech by the first sequence and through a speech learning model 13112 so as to generate a second sequence of the term; and (g) showing the at least a candidate by the second sequence by the monitor 14 and then picking up a term according thereto.

According to the foregoing, the present invention provides an inputting device and method employing the combination of an associated character input method and an automatic speech recognition method, which can be used in a mobile communication apparatus. The method combines the advantages of the associated character input method and the speech recognition, so it provides a more convenient and faster text input interface for the user.

While the application has been described in terms of what are presently considered to be the most practical and preferred embodiments, it is to be understood that the application need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present application which is defined by the appended claims.

What is claimed is:

1. A text input device for a mobile communication apparatus, comprising:
an inputting device for inputting a code of a term according to an associated character input algorithm;
a receiver receiving a speech according to a speech recognition algorithm; and
a microprocessor coupled to the inputting device and the receiver, generating at least a candidate of the term according to the associated character input algorithm and comparing the at least a candidate with the speech according to the speech recognition algorithm so as to select out the term from the at least a candidate.

2. The text input device as claim 1, wherein the term is one selected from the group consisting of a separate word, a word string, a cipher and a commonly used symbol.

3. The text input device as claim 2, wherein the separate word is one selected from the group consisting of a Chinese word, a Japan word, a Korean word, an English word, a German word, a French word, a Spanish word, an Arabic word, a Russian word, an Italic word, a Portuguese word, a Netherland word, a Greek word, a Czech word and a Denmark word.

4. The text input device as claim 2, wherein the word string is composed of at least a letter and is one selected from the group consisting of an English word string, a German word string, a French word string, a Spanish word string, an Arabic word string, a Russian word string, an Italic word string, a Portuguese word string, a Netherland word string, a Greek word string, a Czech word string and a Denmark word string.

5. The text input device as claim 2, wherein the code is one selected from the group consisting of the letter, the phonetic symbol and the cipher.

6. The text inputting device as claim 2, wherein the microprocessor further comprises:
a memory device, storing:
a data base, comprising:
an associated character input dictionary generating the at least a candidate according to the code; and
a speech learning model;
the associated character input algorithm; and
the speech recognition algorithm; and
a microcontrol unit coupled to the memory device, performing the associated character input algorithm and the speech recognition algorithm and comparing the at least a candidate with the speech according to the speech learning model so as to obtain the term.

7. The text input device as claim 6, wherein the associated character input dictionary stores the letter, the phonetic symbol, the separate word, the cipher, and the commonly used symbol.

8. The text input device as claim 6, wherein the associated character input algorithm generates a first sequence according to a use frequency of the at least a candidate from high to low.

9. The text input device as claim 8, wherein the speech recognition algorithm compares the at least a candidate with a pronunciation of the speech by the speech learning model according to the first sequence so as to generate a second sequence and pick up the term according thereto.

10. The text input device as claim 9, wherein the text input device further comprises a monitor coupled to the microprocessor and shows one selected from the group consisting of the code, the at least a candidate and the term.

11. The text input device as claim 10, wherein the monitor shows the at least a candidate according to the first sequence and the second sequence.

12. The text input device as claim 1, wherein the inputting device inputs at least one selected from the group consisting of a letter, a phonetic symbol, a plurality of commonly used symbols and a cipher.

13. The text input device as claim 12, wherein the phonetic symbol is one selected from the group consisting of a Chinese phonetic symbol, a Japan phonetic symbol and a Korean phonetic symbol.

14. The text input device as claim 1, wherein, when two codes from the inputting device are respectively inputted by two different input methods, the two codes are inputted directly through the inputting device according to the two different input methods without switching.

15. The text input device as claim 1, wherein the speech is a speech of the term pronounced by a user.

16. The text input device as claim 1, wherein the mobile communication apparatus is one of the mobile phone and the personal digital assistant.

17. A text input device for a mobile communication apparatus, comprising:
an inputting device inputting a code of a term;
a receiver receiving a speech; and
a microprocessor coupled to the inputting device and receiver, comprising:
a memory device, comprising:
a data base, comprising:
an associated character input dictionary generating at least a candidate of the term according to the code; and
a speech learning model;
an associated character input algorithm generating a first sequence of the at least a candidate; and
a speech recognition algorithm generating a second sequence of the at least a candidate; and
a microcontrol unit coupled to the memory device, performing the associated character input algorithm and the speech recognition algorithm and comparing the at least a candidate with the speech according to the speech learning model and the first sequence so as to generate the second sequence for picking up the term.

18. The text input device as claim 17, wherein the inputting device inputs one selected from the group consisting of an English letter, a phonetic symbol, plural commonly used symbols, and a cipher.

19. The text input device as claim 17, wherein the associated character input dictionary stores plural phonetic symbols, plural English letters, plural Chinese words, plural English words, plural ciphers, and plural commonly used symbols.

20. The text input device as claim 17, wherein the term is one selected from the group consisting of a Chinese word, an English word string, an English word, a cipher, and a commonly used symbol.

21. The text input device as claim 20, wherein the English word string is composed of at least an English letter.

22. A text input method for a mobile communication apparatus having an input device comprising an inputting device, a receiver, a monitor, and a data base having an associated character input dictionary and a speech learning model, comprising steps of:
(a) inputting a code selected from the group consisting of a letter, a phonetic symbol, plural, commonly used symbols, and a cipher through the inputting device;
(b) showing in the inputted code by the monitor;
(c) checking whether the code is inputted completely, if yes, searching the associated character input dictionary so as to show at least a candidate by a first sequence according to the code, and, if not, repeating steps (a) and (b);
(d) inputting a speech from the receiver;
(e) comparing a pronunciation of the at least a candidate with the speech by the first sequence through the speech learning model so as to generate a second sequence;
(f) showing the at least a candidate by the monitor according to the second sequence and then picking up a term; and
(g) showing the term by the monitor.

23. A text input method for a mobile communication apparatus, comprising steps of:
(a) inputting a code according to an associated character input method;
(b) showing the inputted code by the mobile communication apparatus;
(c) checking whether the code is inputted completely, if not, repeating steps (a) and (b), and, if yes, generating at least a candidate of a term and a first sequence according to the associated character input method and the code;
(d) showing the at least a candidate in the mobile communication apparatus according to the first sequence;
(e) inputting a speech;
(f) comparing a pronunciation of the at least a candidate with the speech by the first sequence and through a speech recognition method so as to generate a second sequence of the term; and
(g) showing the at least a candidate by the second sequence in the mobile communication apparatus and then picking up a term according thereto.
